(19) United States
(12) Patent Application Publication
(10) Pub. No.: US 2012/0019465 A1
(43) Pub. Date: Jan. 26, 2012

(54) Directional Pad Touchscreen

(75) Inventors: Charles L. Chen, San Jose, CA (US); Tiruvilwamalai Venkatram Raman, San Jose, CA (US)

(73) Assignee: GOOGLE INC., Mountain View, CA (US)

(21) Appl. No.: 13/249,595

(22) Filed: Sep. 30, 2011

Related U.S. Application Data
(63) Continuation of application No. 12/774,518, filed on May 5, 2010.

(51) Int. Cl. G06F 3/041

(52) U.S. Cl. 345/173

(57) ABSTRACT

A computer-implemented user interface method for managing directional user inputs is disclosed. The method includes receiving sliding motion by a user on a touchscreen of a computing device, identifying a direction for the sliding motion; associating the direction for the sliding motion with one of a plurality of directions for a directional pad, and providing information about the associated one of the plurality of directions to an application that is executing on the computing device.

### CROSS REFERENCE TO RELATED APPLICATION

This patent application is a continuation (and claims the benefit of priority under 35 U.S.C. §120) of U.S. patent application Ser. No. 12/774,518, filed on May 5, 2010. The disclosure of U.S. patent application Ser. No. 12/774,518 is considered part of (and is incorporated by reference into) the disclosure of this application as if set forth herein in full.

### TECHNICAL FIELD

This document relates to user interfaces for computing devices such as mobile devices in the form of smart phones or app phones.

### BACKGROUND

Mobile computing continues to grow quickly as mobile devices, such as smart phones, add more power and more features. Users of such devices may now access various services on the internet, such as mapping applications, electronic mail, text messaging, various telephone services, general web browsing, music and video viewing, and similar such services. Users can interact with the devices through various types of controls upon the surface of the devices, such as buttons, directional pads, and trackballs, as well as touchscreen interfaces. Because the physical control layout can vary dramatically from device-to-device, it may be difficult to interact immediately and easily with a new device.

In addition, interaction with a mobile device may occur in a variety of situations, in varying levels of concentration for a user. At one end of a spectrum, a user may be able to provide full attention to their device, such as when they are at their desk or riding on mass transit. At the other end of the spectrum, a user may be busy having a conversation or driving their automobile, so that any interaction with their mobile device should require a minimum amount of attention from the user.

### SUMMARY

This document describes systems and techniques that a user may employ in order to enter information into a mobile computing device. In general, an application or an operating system on a mobile device may associate directional gestures on the touchscreen—independent of where they occur (i.e., where dragging motions start and/or stop) on the touchscreen—with directional inputs on a directional pad, which is a well-known input mechanism whereby pressing on the perimeter of the pad results in a directional input to the side of the pad that a user presses (and pressing the middle of the pad can, in certain examples, cause a selection command to be generated).

The initial point of contact by a user on a touchscreen (e.g., with the user's fingertip) may establish an anchor point that is then used to identify a subsequent direction of input by a user (e.g., via a sliding or dragging motion or a second press on the screen). The direction may be mapped to a virtual directional point on a directional pad (e.g., right, left, up, or down), with the sliding direction representing a desired button in the relevant direction from the center button. In addition, feedback may be provided to a user to indicate the control selection that has been registered in response to their input, such as by having a device speak the input associated with the control selection. Such feedback may come in a number of forms, such as spoken (e.g., synthesized or digitized speech), auditory (e.g., tones or clicks), and tactile (e.g., rumble or tap) feedback, where such feedback is synchronized to registration of the inputs. Thus, in addition to hearing the value of a control selection spoken, a user may also hear a short sound, synchronized with tactile feedback such as vibration. Such feedback may improve the sensation of “moving over” or “pressing” a button. Also, although the system described here may be directed to eyes-free input modes, a visual indication may also be provided on the touchscreen of the device. For example, a virtual directional pad may be superimposed over other objects on the screen when the device is in a mode for receiving such input, and a visual indication, such as highlighting one side of the directional pad, may be made when the user's device registers an input. In such an example, the user's input would not have to occur on top of the virtual directional pad itself, but would be registered by the direction of the user's dragging or sliding input, regardless of the particular location that the input was made. (The input location can be independent of the location of the directional pad when it does not have to occur at the location of the corresponding displayed portion of the directional pad, regardless of whether there may be certain areas of the screen where directional input cannot be made, such as in a status bar area of a display or in other areas.)

In one example, a directional pad (D-pad) system may be provided. The D-pad, for example, can be envisioned as including buttons or directional portions within the cardinal directions, such as an upward (North) button, a downward (South) button, a left (West) button, and a right (East) button. The upward, downward, right, and left buttons may optionally surround a center button. In another example, the virtual D-pad can include intermediate directional buttons, such as upper-right, lower-right, upper-left, and lower-left controls. A user's initial point of contact with a touchscreen may be taken by the system as a base location for sliding input entry. Subsequent dragging, or sliding, by the user in a radial direction (where the dragging does not have to occur in a straight line) may select a control, icon, or command available through the touchscreen interface that corresponds to a selection that would be made on a D-pad, whether or not the user's contact on the screen is actually over a control or icon that might be displayed on the user interface within the screen. For example, dragging downward relative to the initial point of contact may indicate depression (and release) of a down arrow button of a virtual D-pad, while dragging in a right or East direction may represent depression of a right arrow button of a virtual D-pad. Particular strokes may indicate entries of keys that are not directly radially related to the virtual D-pad, such as a tap indicating a depression of the center button of the D-pad. Other inputs, such as shaking and/or tilting the device, can provide other commands or augmented commands.

In certain embodiments, the features discussed here may provide one or more advantages. For example, a user can enter data into a device without having to look at the device, where the data input is determined by a direction of input, and where the initial point of input from the user is independent of the control selection to be entered. In particular, the user may operate a mobile device without having to take their visual attention away from another activity. Moreover, such a system may be learned in certain implementations without a user having to learn an input lexicon. Also, vision-impaired users may more easily interact with a computing device having a touchscreen interface. Such features may have benefits in terms of better usability and safety.

The details of one or more embodiments are set forth in the accompanying drawings and the description below. Other features and advantages will be apparent from the description and drawings, and from the claims.

### DESCRIPTION OF DRAWINGS

FIG. 1 shows example screenshots of a mobile device providing for touchscreen user input.

FIG. 2 is a block diagram of a system for providing quick touchscreen user input.

FIG. 3A is a flowchart of a process for receiving touchscreen user inputs.

FIG. 3B is a flowchart of a process for interpreting touchscreen inputs on behalf of applications for which a user makes the inputs.

FIG. 4 is a swim lane diagram of a process by which a gesture tracking module interfaces between a computer application and a touchscreen.

FIG. 5 shows an example of a computer device and a mobile computer device that can be used to implement the techniques described here.

Like reference symbols in the various drawings indicate like elements.

### DETAILED DESCRIPTION

This document describes systems and techniques for receiving user input on a touchscreen of a computing device in a manner that is relatively quick and involves reduced user visual attention to the input process. The user input may begin with a user contact (e.g., a finger touch) on a touchscreen and may proceed with an additional user input in a direction from the initial user contact, such as by the user dragging or sliding their finger in a direction measured radially from the initial point of contact. The particular direction of the dragging may represent an intended input that corresponds to a key on a virtual directional pad, or D-pad, that is located in the respective direction from the center of the D-pad, such as a center button control. Thus, for example, the point of initial contact may be assumed to be a center button of a D-pad, whereas a direction of the subsequent user input may represent a button, or direction portion of the D-pad, on a side of the D-pad relative to the center button, that the user would like to press. In certain scenarios, the D-pad need not be shown on the display in order for the inputs to be mapped to the D-pad, or the inputs need not be aligned with the D-pad if it is displayed.

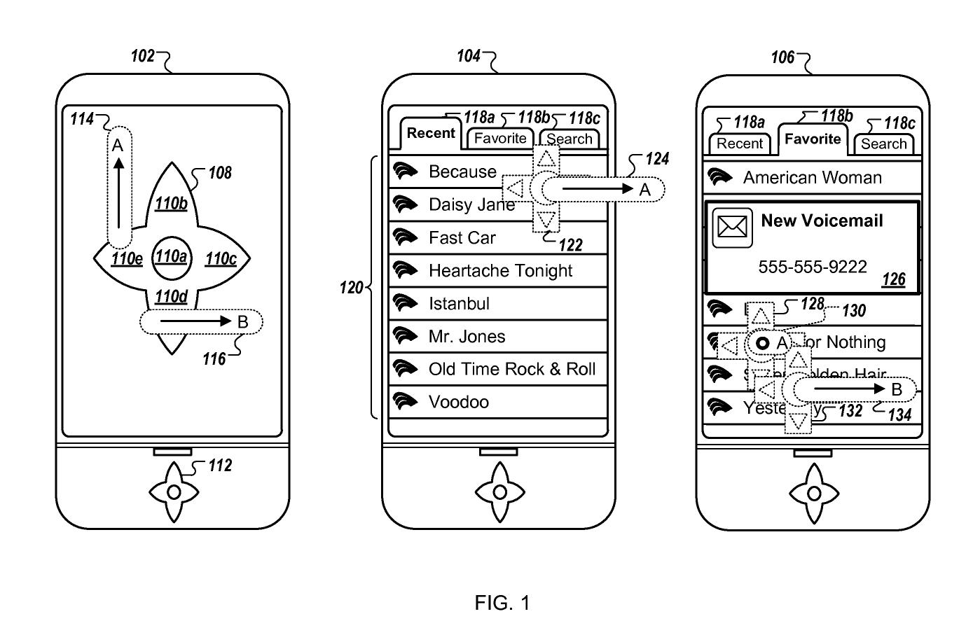

FIG. 1 shows example screenshots of a mobile device that provides for touchscreen user input. In general, three different displays 102-106 are shown to provide examples that demonstrate how the techniques described here can be implemented. Each of the displays 102-106 are shown on a mobile device that has a touchscreen graphical user interface, where the device may be loaded with a number of computer applications, including a music player application and a voicemail application.

Display 102 shows an example of virtual D-pad input by a user of the device. The display 102 looks like a standard smart phone, including a virtual D-pad 108 centered within the screen area. The virtual D-pad 108, for example, is generated to resemble a directional pad 112 at the bottom of the display 102. The virtual D-pad 108 includes a center button 110a, an upwards button 110b, a right button 110c, a downwards button 110d, and a left button 110e. In a typical configuration, the user may simply use the directional pad 112 to enter directional inputs in a familiar manner. However, such entry requires the user to know where the directional pad 112 is located and how the directional pad 112 is configured. For example, different touchscreen devices can have different D-pad styles, and some touchscreen devices may have a different layout of physical controls, such as multiple control buttons or a trackball, rather than the directional pad 112. When switching from device to device, for example, the user may find the need to re-orient with the new input button layout and style.

As a result, an alternative (or in this case, additional) data entry technique is provided on the device. In particular, because normal user interaction on the interface 102 involves tapping and dragging, the system can recognize tapping and dragging motions as involving an alternative user intent (e.g., not indicating the information positioned below the user's finger). In particular, sliding motions on the display 102 may be interpreted to be directed at entering D-pad button activation information whose value is based on a direction of the sliding.

Two such sliding examples, shown on display 102, illustrate this point. A first sliding example 114, labeled “A”, represents a path of a user's finger dragging across the display 102—here, in an upward or North direction. The sliding motion starts with an initial user contact over the left button 110e of the virtual D-pad 108, but the ultimate input is determined independent of that particular correspondence between the contact point and the currently-displayed selection under the contact point. Rather, the control that is deemed to be input by the user is the particular button 110—on the virtual D-pad 108 shown on the display 102—that is in the dragged direction relative to the initial contact point. In this example, the upward button 110b is in the upward direction in relation to the center of the virtual D-pad 108, so the system can interpret the sliding motion labeled “A” as selection of the upward button 110b. If the user input had been determined simply to be a contact followed by a release, rather than a sliding motion, the system may have registered the input as being the left button of a D-pad rather than the upward button.

A second sliding example 116, labeled “B”, represents a follow-up input by the user. This time, the user starts generally over the downward button 110d of the virtual D-pad 108 and drags to the right, or East. Again, the interpreted input is deemed to have started at the center of the virtual D-pad 108, and to have selected the particular button 110 on the dragged direction of the virtual D-pad 108, which here is the right or East button 110c. The actual starting point of the sliding example 116 did not matter—rather, what mattered was the direction of the sliding.

In certain examples, the general location of the start of a sliding operation may have some effect on the input, as that input is interpreted by a device. For example, a screen may be split into two portions so that selections in directions on one half of the screen are interpreted in a different manner than selections in the same directions on the other half of the screen. Still, however, the selections may be independent of the actual location of the initial contact, in that any sliding motion in the appropriate direction in the designated area will have the same result, regardless of where in that designated area the sliding motion began.

In certain situations, like that shown in display 102, not all of the relevant controls will be arrayed in a single radial direction from an anchoring point, such as the center button 110a. In those situations, additional gestures may be used to signal an intent to enter such additional controls. For example, a single tap may represent an intent to select the center button 110a. Other times, multiple taps or dragging other than in a radial direction may indicate such an intent. For example, drawing a circle—though it may be slower than a straight radial drag—may be used to indicate an intent to select the center button 110a of the virtual D-pad or to make another selection. Other tapping or curved gestures may represent an intent to repeat a previous input.

Other actions by a user may be used to change an input mode of the device. For example, a status of an application or a user input may change the device into a mode in which is receives directional inputs like those described here. Other inputs or contextual situations, may affect changes in the manner in which inputs are received and processed. For example, if a telephone application is the focus of a device, rather than a directional application, radial dragging may be interpreted, not as relating to the particular D-pad buttons around a center button, but to selection of particular telephone keys on a dialing pad. For example, dragging up may be interpreted as an intent to press the “2” key, while dragging down and to the right could represent an intent to select the “9” key, and tapping may show an intent to select the “5” key.

Also, a virtual D-pad may be superimposed over other selectable items that are displayed on a touchscreen or may be invisible. In such a situation, the decision by a device to accept a sliding input as a directional input may be based on one or more factors. For example, a device may be put explicitly into a directional input mode so that all sliding or dragging inputs are interpreted as being directional inputs. Alternatively, or in addition, sliding or dragging motions may be interpreted as being directed, not to an application but instead as directional inputs, when the area of the application that is being displayed under the inputs does not accept such inputs (so that the device can assume that the inputs are not directed to that area of the application).

Display 104 provides an example similar to that in display 102, but over a music player application for a mobile device. In particular, the display 104 shows a set of selection tabs 118, including a recent tab 118a, a favorite tab 118b, and a search tab 118c, and a set of song titles 120, displayed together in the screen area of the display 104. In this example, one user sliding selection is displayed in relation to a virtual D-pad 122. The D-pad 122 is shown dashed here to indicate that its display on the screen may be partially translucent (and generated only once the user begins dragging a finger across the display 104) or wholly invisible. A sliding selection 124, labeled “A”, has been made by a user in a rightward direction from the center of the virtual D-pad 122. Thus, if the relevant input mode of the device at the time of the entries was for a virtual D-pad or an application coordinating with inputs from a virtual D-pad, the user selection may represent an intent to select the “favorite” tab 118b because that tab is to the right of the currently-displayed tab 118a, and is the only selection in a rightward direction that makes sense on the display 104. In this example, it does not matter that the dragging selection 124 does not physically land within the tab area of the display. Rather, the direction of the dragging motion itself was what mattered.

In this example, the dragging motion is shown as continuing off the edge of display 104. Such an action may have no effect or may be interpreted as a device as having special significance. For example, if the device recognizes dragging as occurring to the edge of the display 104 (and thus presumably off the edge), it may interpret such input as calling for extra motion in the selected direction (e.g., as equivalent to two or more taps on the corresponding side of the D-pad). The dragging may also occur off the edge of the touchscreen and onto one or more buttons that are array off the edge of the touchscreen, and such action may be interpreted by the device as calling for an action that corresponds to the selected button.

The user data entries may be interpreted in other contexts, also, and the particular context may be set in a number of different ways. As one example, user entries on the desktop may be assumed, initially, to relate to the elements on the desktop, so that, for example, tapping an icon causes an application associated with the icon to be launched, and dragging on an icon causes the icon to be relocated. However, if a user makes an input action to display 104, where the action does not correspond to an action supported by the display 104 at the current time and the selected location, the action may be taken by the device as directed at an alternative action. For example, if a user presses down on an icon and drags it to a location at which it cannot be dropped, such a seemingly incongruous action may be interpreted as being directed to an alternative input mechanism on the device, which will involve interpreting the input according to the direction of the dragging. If, for example, the user on display 104 had made a sliding selection in an upwards or downwards direction, the action may have been interpreted as a scrolling gesture within the set of song titles 120.

Also, a particular user gesture may be used to activate such an alternative input mechanism. For example, if a user traces a circle over a desktop, such an action may activate the alternative input mechanism. Also, accelerometer input may be taken as an indication to provide for an alternative input mechanism, such as by a user shaking the device in a particular manner. Also, if the device senses other environmental variables, such as by sensing that its front side or screen is close to an object (e.g. it is in a user's pocket or close to the user's head), the alternative input mechanism may be automatically enabled.

A user may be able to specify which application, of several applications, will be enabled when an alternative input mechanism is acting over a desktop. For example, in an operating system configuration screen or in a configuration screen for the alternative input mechanism, the user can identify an application to which input data is to be passed (such as a voice mail system) when no other application is an obvious recipient of the input (such as when no other application is active, or the focus of the device). Also, a user may speak the name of an application to enable alternative touch input for that application.

One such user example may better highlight the concepts discussed here. For example, a user may speak the word “D-pad” to have their device change to a mode in which virtual D-pad input may take place. The voice input may launch a virtual D-pad application and may also cause that application to be displayed in place of a desktop that was previously shown on the display, as with display 102. Alternatively, the virtual D-pad may be invoked and not displayed, or only displayed upon contact, as with display 104. The user may then make sliding motions on the display in particular directions to enter D-pad button or directional selections. Each such input motion, regardless of its length, may cause corresponding motion for a single D-pad touch.

A device may also provide audible feedback in the form of the content of an interpreted data entry intent. Referring to display 104, when a user drags to the right within the sliding selection 124, their device may speak “favorite.” If they then repeat the gesture, the device may speak “search.” If the user then drags their finger left, the device may speak “favorite,” and after another drag left, the device may speak “recent.” The spoken value may also be combined with an audible tone or other similar sound so as to more quickly indicate when an input value has been registered by the system. In addition, the device make shake slightly when each input is registered, so as to give the user immediate feedback that the entry has been recognized.

In some implementations, the device may provide audible feedback regarding the direction selected (e.g., “up”, “down”, “forwards”, or “back”) or an inconsistency in the direction selected (e.g., “unknown” or “selection not clear”). This may occur, in some examples, if the angle of the sliding motion is too far removed from one of the cardinal directions or if the sliding motion including a significant curve. The user, for example, may be provided the opportunity to provide a corrective sliding motion in response to an unknown condition.

Additional feedback may be provided tactilely. For example, as noted above, a device may vibrate slightly when a gesture made by a user is registered by the device, so that the user will know that they can move on to providing further input. Such feedback may be provided in place of audible feedback or may be in addition to audible feedback, so as to reinforce the message provided by the audible feedback. In this manner, the user may be provided an improved sensation of pressing or rolling over a certain selection (even though their actual finger may not be rolling over any visible element on the touchscreen).

Referring now to the third display in the FIG. 1, display 106, a scenario like that shown in display 104 is provided. In this example, a voicemail indication message box 126 has been superimposed over the music player application. Behind the message box 126, the favorite tab 118b has been selected, for example based upon the user input received through the dragging selection 124 within the display 104. Along with the message box 126, an audible or tactile feedback may have alerted the user to the presence of new voicemail.

To access the new voicemail message, the user may input one or more gestures to a virtual D-pad application. In this example, two user inputs are registered by the display 106. A first user tapping selection 130 is displayed in relation to a first virtual D-pad 128 (e.g., shown in a translucent manner). The tapping selection 128, labeled “A”, may be made by the user tapping the touchscreen. The virtual D-pad 128, for example, is illustrated centered upon the user's point of contact. The tapping selection 130 is followed by a second user sliding selection 134, labeled “B”, radiating from the center of a second virtual D-pad 132 (e.g., shown in a translucent manner). As illustrated, the virtual D-pads 128 and 132 may not necessarily coincide or overlap with each other, and one or both of the virtual D-pads 128 and 132 may land outside the message box 126. In some implementations, the first tapping selection 128 is received prior to the second sliding selection 134 to differentiate the intentions of the user from an intent of selecting between the tabs 118 of the music application. In other implementations, only the second sliding selection 134 is necessary, because the virtual D-pad input is assumed to be related to the active content within the display 106 (e.g., the message box 126).

When combinations of virtual D-pad inputs are utilized to provide input to a touchscreen, the timing or relative orientation of the virtual inputs may be considered when interpreting the intentions of the user. For example, the sliding selection 134 may need to be made in a relatively short timeframe after the tapping selection 130 for the system to associate the two gestures as being related.

In certain implementations, the data may be associated with a particular application only after the data has been entered by a user. For example, if a user enters one or more tapping or sliding selections and then provides an indication that they are finished providing input (e.g., by tapping or shaking their device), an interface module may infer that the person entered a virtual D-pad selection and may provide the selection to an input method editor (IME) on the device, or an IME may decide to interpret the input as directional and provide such directional information to an application that is executing on the device. Alternatively, a device may identify several possible uses for the input and may ask a user for an additional entry that indicates how they would like the input used.

Although the description here is presented in terms of substantially straight-line dragging gestures that are parallel or orthogonal to the edges of the screen area of the device, dragging gestures in a range of degrees offset from the vertical or horizontal may be translated to be indicating a vertical or horizontal input. For example, a dragging gesture up to fifteen degrees North of West can be translated as a dragging gesture in the direction of West.

If the mobile device can determine a degree of tilt in relation to horizontal (e.g., using an on-board accelerometer), the tilt of the device may be built into the range estimation regarding the user's intended direction of a dragging gesture. For example, if the device is being held at 30 degrees offset from the horizontal, a sliding motion up to forty-five degrees North of West (e.g., 30 degrees in addition to the fifteen degrees used in the previous example) may be translated as a sliding motion in the direction of West. The range of estimation involved, in part, can be determined based upon the number of directional inputs available to the user. For example, a four-button virtual D-pad may accept a greater degree of inaccuracy than an eight-button virtual D-pad (e.g., including the cardinal directions plus Northeast, Northwest, Southeast, and Southwest controls).

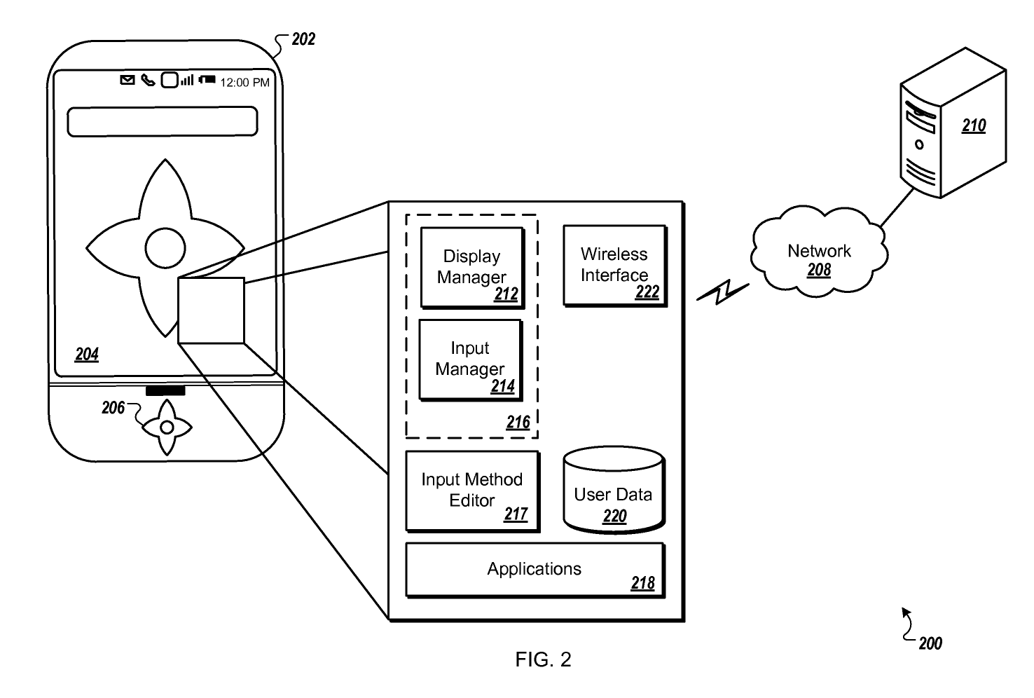

FIG. 2 is a block diagram of a system 200 for providing quick touchscreen user input. In general, the system is represented by a mobile device 202, such as a smart phone, that has a touchscreen user interface 204. In addition, the device 202 may have alternative input mechanisms, such as a directional pad 206 and other selectable buttons. A number of components within the device 202 may provide for such interaction by the device 202. Only certain example components are shown here, for purposes of clarity.

The device 202 may communicate via a wireless interface 222, through a network 208 such as the internet and/or a cellular network, with servers 210. For example, the device 202 may carry telephone calls through a telephone network or through a data network using VOIP technologies in familiar manners. Also, the device 202 may transmit other forms of data over the internet, such as in the form of HTTP requests that are directed at particular web sites, and may receive responses, such as in the form of mark-up code for generating web pages, as media files, as electronic messages, or in other forms.

A number of components running on one or more processors installed in the device 202 may enable a user to have simplified input on the touchscreen interface 204. For example, an interface manager 216 may manage interaction with the touchscreen interface 204, and may include a display manager 212 and a touchscreen input manager 214.

The display manager 212 may manage what information is shown to a user via interface 204. For example, an operating system on the device 202 may employ display manager 212 to arbitrate access to the interface 202 for a number of applications 218 running on the device 202. In one example, the device 202 may display a number of applications, each in its own window, and the display manager may control what portions of each application are shown on the interface 202.

The input manager 214 may control the handling of data that is received from a user via the touchscreen 204 or other input mechanisms. For example, the input manager 214 may coordinate with the display manager 212 to identify where, on the display, a user is entering information so that that the device may understand the context of the input. In addition, the input manager 214 may determine which application or applications should be provided with the input. For example, when the input is provided within a text entry box of an active application, data entered in the box may be made available to that application. Likewise, applications may subscribe with the input manager 214 so that they may be passed information entered by a user in appropriate circumstances. In one example, the input manager 214 may be programmed with an alternative input mechanism like those shown in FIG. 1 and may manage which application or applications 218 are to receive information from the mechanism.

An input method editor (IME) 217 may also be provided for similar purposes. In particular, the IME 217 may be a form of operating system component that serves as an intermediary between other applications on a device and the interface manager 216. The IME 217 generally is provided to convert user inputs, in whatever form, into textual formats or other formats required by applications 218 that subscribe to receive user input for a system. For example, the IME 217 may receive voice input, may submit that input to a remote server system, may receive back corresponding textual data, and may pass the textual data to an active application. Similarly, the IME 217 may receive input in Roman characters (e.g., A, B, C . . . ) in pinyin, and may provide suggested Chinese characters to a user (when the pinyin maps to multiple such characters) and then pass the user-selected character to a subscribing application. Relevant to the input techniques discussed above, the IME 217 may also interpret dragging inputs to produce D-pad outputs in the direction of the dragging. For example, an application that wishes to take advantage of a D-pad interface may register (e.g., when it is executed) with the IME 217, designating certain motions as corresponding to standard control inputs, such as a downward sliding motion corresponding to the downward directional portion of a D-pad control.

In certain embodiments, applications 218 may instead initially register with a gesture interface helper function when they are originally launched. For example, the applications 218 may identify one or more directions for which it would like to receive inputs, e.g., by designating a downward sliding motion as a south button control for a virtual D-pad application. Using a known API, for example, the application may submit an array or other data structure of parameters of direction and input keys to be associated with user inputs in those directions. Where multi-direction inputs are to be interpreted, the applications 218 may submit information in a similar, but more expansive, manner. The gesture interface helper function may then interact with the interface manager 216, such as by registering itself with the interface manager 216. The application may also receive data from the IME 217 in a standard form, as if the input were coming from a physical D-pad. Also, a device 202 can pass D-pad information to applications 218 in the same form whether a user enters the information by pressing one side of D-pad 206 or by making directional dragging motions on the display 204.

Along with motions corresponding to control functions, in certain implementations, the IME 217 or gesture interface gesture interface helper function can register certain motions or activities by the user as being indicative of activating the virtual D-pad functionality. For example, the user may indicate a desire to use the input mechanisms described here by placing the device 202 in a pocket, by shaking the device 202 in a particular manner, or by dragging across display 204 in a particular manner. Upon receipt of such an event, for example, the interface manager 216, using the IME 217, may report subsequent inputs as if they were received on a physical D-pad. For example, the interface manager 216 may report the X and Y coordinates of each line traced by a user or of points along a curve or other pattern traced by the user to the IME 217. The interface manager 216 may also report if the user entered any taps and where those taps occurred on the display 204.

The IME 217 or gesture interface helper function may then interpret such input and report it in an appropriate manner to the relevant application or applications 218. For example, the gesture interface helper function may report a direction of a sliding motion and the occurrence of any taps relevant in time to the sliding motion, and the application may interpret such data. Alternatively, the IME 217 may interpret the data in a greater manner, such as by correlating a certain sliding direction with a control input that was previously registered as corresponding to the direction. The IME 217 may then pass the control input to the application, such as in the same form as if the input were received on a physical D-pad.

The IME 217 or gesture interface helper function may also reformat data in other manners. In one example, a music player application may not have been written to work with the input mechanisms described here. Instead, the music player may receive information about which objects (in the form of virtual D-pad buttons) have been pressed by a user. The IME 217 or gesture interface helper function may be programmed to reside in a communication channel between the interface manager 216 and the application, and may convert directional sliding inputs into the form of messages that the music player application expects to see from the interface manager 216. In this manner, the system 200 can provide a number of different manners in which to provide quick user touchscreen input to one or more applications running on device 202.

Finally, a user data database 220 may store information about particular user preferences or parameters. For example, the database 220 may store an identifier of an application that is to receive input from the interface manager 216 or IME 217 in various contexts. As one example, a voicemail application may be set by default to receive such input when the input is made over an operating system desktop. The user data database 220 may also include information such as the type of virtual D-pad a user prefers to have their inputs mapped to (e.g., four-directional with a center button, eight-directional, etc.), and other relevant data needed to provide an alternative mechanism for providing input.

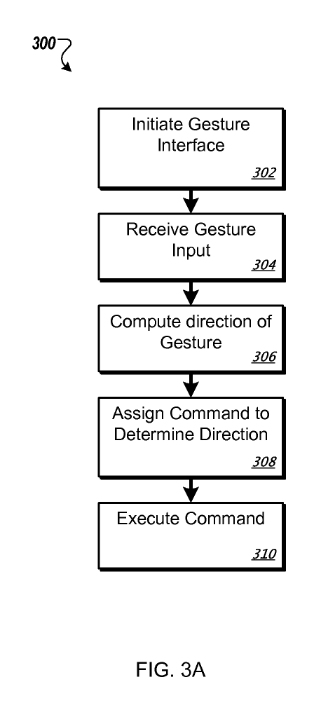

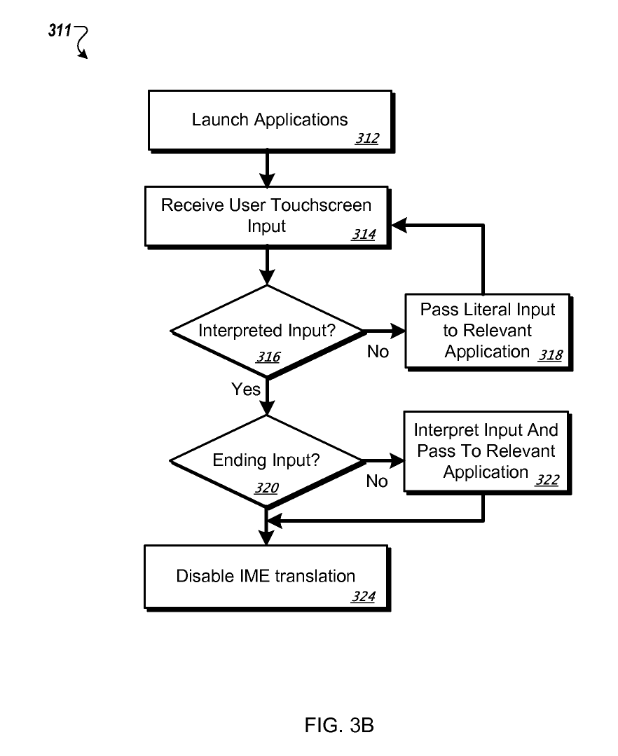

FIG. 3A is a flowchart of a process 300 for receiving touchscreen user inputs. In general, the process involves the use of a gesture tracking program to determine the form of user inputs on a touchscreen interface, and then to convert those inputs into particular commands (e.g., control selections) to be executed on a computing device.

The process 300 begins by the initiation of a gesture interface (302). The gesture interface may, for example, be a component of an operating system that launches when the device is powered up, and that runs in the background to provide for gesture-based input to the system. The tracker may alternatively be an application that is separate form the core operating system, such as a gadget or widget, that communicates with touchscreen managing components of an operating system.

A gesture input is received at box 304. Any contact with the touchscreen may initially be interpreted as a gesture input. Such an input may then go through a filtering process, such as by filtering out contacts that are too broad-based to be intentional inputs because they likely represent accidental contact with something other than a fingertip or stylus. Also, certain inputs may be filtered and passed to various different applications, where one of the applications processes gestures like those described above.

For gestures that are determined to relate to inputs that are to be judged by their direction of dragging relative to a base point, the direction of dragging is computed (306). In particular, endpoints for a dragging operation may be determined in a familiar manner, and the angle between the endpoints may be computed. The angle may be generalized, in addition, such as to a nearest round angle (e.g., the nearest 15 degrees) or nearest compass direction (e.g., one of the eight or sixteen main compass directions). Other representations for an angle or direction of a dragging input or a pair of tapping inputs may also be employed.

A command or control press that has previously been correlated with the direction is assigned to the received gesture (308), and is executed (310). The command may be assigned, for example, by a helper application that is dedicated to receiving data on such user inputs and passing commands to associated applications. In another example, the command may be assigned by an input method editor (IME). Also, applications themselves may correlate a direction with a command or control activation.

FIG. 3B is a flowchart of a process 311 for interpreting touchscreen inputs on behalf of applications for which a user makes the inputs. In general, the process involves tracking user inputs, determining which inputs can be passed literally to an application and which require interpretation, and interpreting the relevant inputs before passing them, as interpreted, to an application.

The process 311 begins by launching one or more relevant applications (312). The application(s) may include end-user applications such as voicemail programs, music player programs, calendar programs, network browsing programs, chat programs, and the like. The application(s) may also include intermediary applications, such as helper applications that work to translate inputs from a touchscreen for direct use by the end-user applications. The applications may perform relevant processes, and at some point, may await events triggered by a user. For example, an event manager may receive information about contacts made with a touchscreen and may alert one or more relevant applications such as an input method editor.

A user touchscreen input is received at box 314. The input could take a variety of forms, such as one or more taps, and one or more sliding or dragging motions that may occur in straight lines, curves, or more complex shapes. It is determined whether the input is in a form that needs to be interpreted (316). For example, if the input is a tap on a program object that is intended to receive user inputs, such as a selectable button, such an action may be reported directly to the application that generated the object (318).

If the input needs to be interpreted, it is determined whether the input is a substantive input or an input to stop the acceptance of such interpreted inputs (320). If it is the latter, a helper application or an IME translation module that assists in interpreting inputs may be closed or disabled (324). For example, a user may have previously had a mobile device in their pocket, with the pocketed device enabled to use a helper application which interprets user inputs that do not require visual attention. Subsequently, the user may have removed the device from the pocket. Such a user may now be able to use a D-pad, control buttons, or a trackball directly by tapping on the physical controls such as the buttons of a directional pad. As such, the user may take an action to move the helper application out of the way in such a situation.

If the interpreted input is not an ending input, then the input needs to be interpreted and passed to the relevant application (322). For example, a user may have input a sliding motion in a particular direction on the touchscreen, where the user understands a particular direction to represent a particular button press. The correlation of that direction to the button press may have been previously registered, and a look-up may be used to identify the button press based upon the direction (e.g., by an IME or a gesture interface helper function). An identifier for the button press may thus be passed to the application, so that the application may register the intended user input.

In this manner, a computing device may be provided with a flexible system by which to aid various applications in receiving input from a user who cannot use their device in an originally-intended manner that requires visual contact with the device. Rather, each application (or the IME or gesture interface helper function itself) may define a number of alternative input gestures that do not require the level of visual attention required by the original gestures, and may receive notice that the original gestures were received by the IME that translates the alternative gestures to the results associated with the original gestures. In the circumstance in which the user desires a universal method of interacting with a number of devices that support a variety of input methods (e.g., different styles of D-pads, trackball, individual directional buttons, etc.), the user can provide input to the device through the touchscreen, irrespective of the physical control layout.

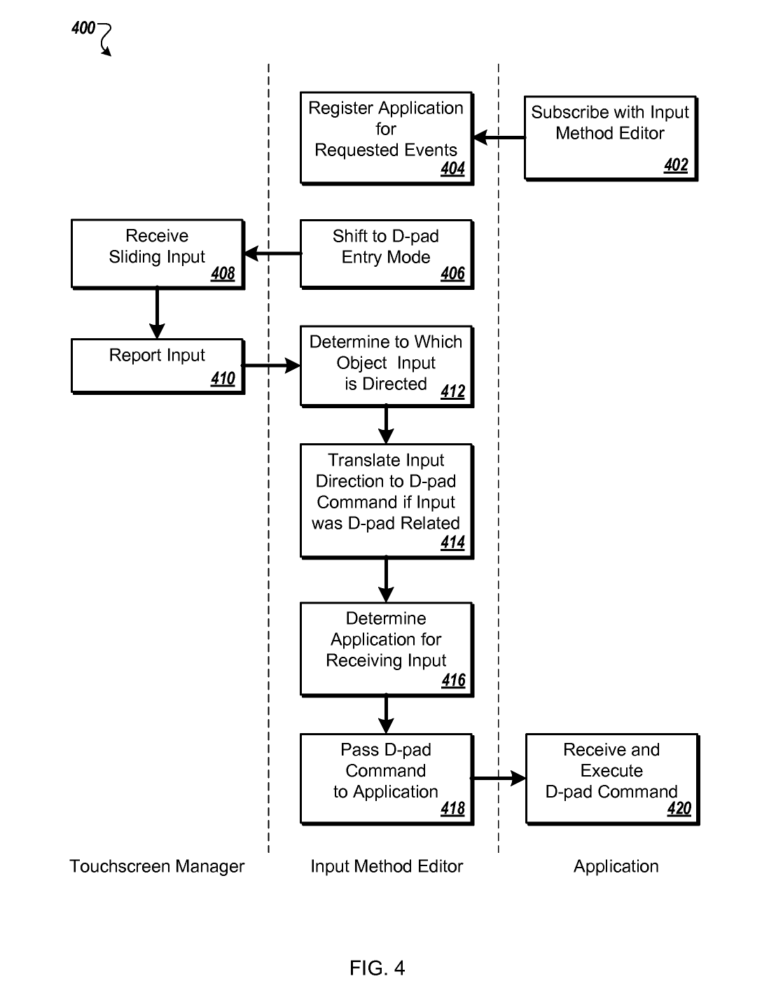

FIG. 4 is a swim lane diagram of a process 400 by which a gesture tracking module interfaces between a computer application and a touchscreen. In general, the process is shown here to highlight one example by which various components may execute to receive user inputs where the user need not be looking at a display on which he or she entered the inputs. Other arrangements and cooperation between and among components may also be used.

The process begins with an application subscribing with an input method editor (IME) (402). The application may take a variety of forms, such as a music player application for a smart phone. The IME registers the application for requested events (404). In some examples, the IME can register the application for inputs related to a physical directional pad or sliding motions related to a virtual directional pad input. Such registration may permit the application to receive D-pad inputs, without the application having to be concerned with whether they were provided by a physical D-pad or a virtual D-pad.

At a later point, the IME shifts to virtual D-pad entry mode (406). For example, this state may be triggered actively by a user (e.g., by saying “D-pad”, selecting a device input related to virtual D-pad mode, or launching the application registered for virtual D-pad input) or passively by the device state (e.g., device placed in a pocket, application entering a mode in which directional input is required, etc.).

A touchscreen manager receives a sliding input at box 408. The sliding input, for example, can be defined by a starting location, an angle of direction, and an end point. The sliding input is reported by the touchscreen manager to the IME (410).

The IME determines an object to which the input is directed (412). For example, the sliding input can correspond to dragging and dropping a control rendered upon in the device display. If the input is related to a virtual D-pad (e.g., there is no corresponding control or the device display is illustrating a virtual D-pad input screen), the IME translates the input to a directional portion of the virtual D-pad (414). For example, the sliding input can be determined to be in a cardinal direction, or, if mimicking an eight-direction D-pad control, between a cardinal direction. The IME may accept a range of angles displaced from the cardinal direction when determining the desired input of the user.

The IME determines an application for receiving the input (416). In some examples, the IME can provide the input to the active application, the application registered as the default application for receiving virtual D-pad input, or another application registered with the IME to receive virtual D-pad events.

The IME then passes the virtual D-pad command to the application (418). In some implementations, the command passed to the application by the IME is no different than the command issued upon receipt of a physical D-pad input. In other implementations, the IME may pass a command specific to virtual D-pad input.

The application receives the virtual D-pad command from the IME and executes one or more events in response to the received input (420). The application, in some examples, can launch an activity, switch to a new activity, or close an activity based upon the input. For example, the virtual D-pad command received by the application may cause the application to play a new voice mail message.

Although described in relation to a single sliding input, the steps of the process 400 can be used to handle input including multiple associated inputs, such as a slide immediately followed by a tap, or one or more slides and taps followed by a gesture registered to the IME as a virtual D-pad input acceptance or rejection input, such as shaking the device.

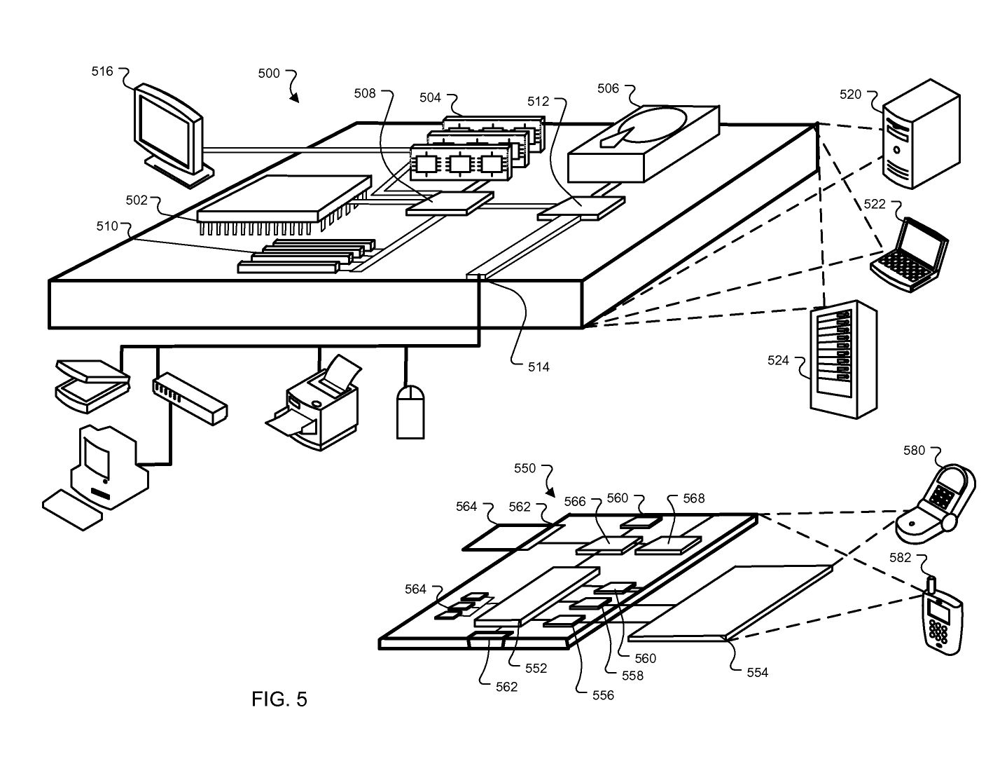

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, much of this document has been described with respect to a telephone dialing application, but other forms of applications and keypad layouts may also be addressed, such as keypads involving graphical icons and macros, in addition to alphanumeric characters.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented user interface method for managing directional user inputs, the method comprising:
receiving sliding motion by a user on a touchscreen of a computing device;
identifying a direction for the sliding motion;
associating the direction for the sliding motion with one of a plurality of directions for a directional pad; and
providing information about the associated one of the plurality of directions to an application that is executing on the computing device.

2. The method of claim 1, further comprising receiving a registration from the application that is executing on the computing device indicating an intent by the application to receive directional pad input information.

3. The method of claim 2, further comprising receiving a press on a directional portion of a physical directional pad on the computing device that is not on the touchscreen, and in response, providing to the application that is executing on the computing device, information indicating the pressing on the directional portion of the physical directional pad.

4. The method of claim 1, further comprising:
receiving a tap input in addition to the sliding motion, the tap input received at a position relative to an ending location of the sliding motion; and
causing an execution of a command associated with the tap input.

5. The method of claim 4, further comprising using the tap input to identify the sliding motion as a non-directional input.

6. The method of claim 1, further comprising providing an audible feedback announcing the providing of information about the associated one of the plurality of directions to the application that is executing on the computing device.

7. The method of claim 1, further comprising providing a tactile feedback to register, with the user, reception of the sliding motion as a recognized directional input.

8. The method of claim 1, wherein the identification of the direction for the sliding motion is independent of a position of the sliding motion relative to items displayed on the touchscreen.

9. The method of claim 1, wherein the association of the direction for the sliding motion with one of the plurality of directions for the directional pad is made independent of a location on the touchscreen at which the sliding motion is received.

10. A computer-implemented user interface method for managing directional user inputs, the method comprising:
associating each of a plurality of cardinal directions on a touchscreen display of a computing device with a cardinal direction for a directional pad input device;
receiving a user contact at a location on the touchscreen display and a sliding input at a direction relative to the location of the user contact;
correlating the direction relative to the location of the user contact to a cardinal direction; and
registering with the computing device a directional pad input that corresponds to the cardinal direction.

11. The method of claim 10, further comprising providing audible feedback concerning a selected directional pad button push during the sliding input, and receiving a corrective sliding input at an angle different than the direction relative to the location of the user contact, wherein the registered directional pad input corresponds to the angle of the corrective sliding input.

12. The method of claim 10, further comprising repeating the steps of receiving, correlating, and registering for each of a plurality of received sliding inputs and registered directional pad inputs.

13. The method of claim 10, further comprising receiving a tap input in addition to the sliding input at a direction relative to the location of the user contact.

14. The method of claim 13, further comprising using the tap input to register with the computing device a selection of a directional pad center button.

15. The method of claim 10, further comprising providing an audible feedback announcing orally the cardinal direction of the registered directional pad input.

16. The method of claim 10, further comprising:
receiving, from a computer application executing on the computing device, enrollment information identifying an intent to receive directional pad input;
upon registering with the computing device a directional pad input, determining whether the computer application is a current application of focus for the computing device; and
based on determining whether the computer application is the current application of focus for the computing device, providing information regarding the registered directional pad input.

17. A computer-implemented data entry system for managing directional user inputs, the system comprising:
a touchscreen input manager to receive and interpret user inputs on a touchscreen of a computing device;
one or more computing applications; and
a gesture interface to receive registrations from the one or more computing applications and to convert sensed input sliding directions on the touchscreen into directional pad input data whose cardinal directions correspond to the input sliding directions, and to provide the directional pad input data to the one or more computing applications.

18. The computer-implemented system of claim 17, wherein the gesture interface provides directional pad input data independent of an actual starting location of a sliding input on the touchscreen.

19. The computer-implemented system of claim 17, wherein, when the gesture interface is invoked, the gesture interface superimposes a graphical representation of a directional pad over an existing graphical interface on the touchscreen.

20. The computer-implemented system of claim 17, wherein the gesture interface is programmed to generate data for producing an audible signal indicating values of directional pad data determined by the computing device.

21. A computer-implemented data entry system, comprising:
an electronic touchscreen display;
a touchscreen input manager to receive and interpret user inputs on the electronic touchscreen display;
one or more computing applications executable to receive input on the touchscreen display; and
means for providing directional user-entered data from the touchscreen to the one or more computing applications, wherein the directional user-entered data is correlated to cardinal directions for a directional pad input device.
